(19) United States
(12) Patent Application Publication
(10) Pub. No.: US 2014/0206217 A1
(43) Pub. Date: Jul. 24, 2014

(54) SOCKET AND LUMINAIRE

(71) Applicant: TOSHIBA LIGHTING & TECHNOLOGY CORPORATION, Kanagawa (JP)

(72) Inventor: Takeshi Osada, Kanagawa (JP)

(73) Assignee: Toshiba Lighting & Technology Corporation, Kanagawa (JP)

(21) Appl. No.: 13/793,239

(22) Filed: Mar. 11, 2013

(30) Foreign Application Priority Data
Jan. 21, 2013 (JP) 2013-008550

(51) Int. Cl. H01R 33/08

(52) U.S. Cl. CPC H01R 33/08
USPC 439/240

(57) ABSTRACT

According to one embodiment, a socket is for mounting a straight tube type lamp by inserting a pair of lamp pins protruding from a cap of the straight tube type lamp and by rotating the pair of lamp pins to a mount position. A rotor which rotates together with the pair of lamp pins is disposed in a socket body. The rotor pushes and expands an interval between a pair of terminals in the socket body.

### INCORPORATION BY REFERENCE

The present invention claims priority under 35 U.S.C. §119 to Japanese patent Application No. 2013-008550 filed on Jan. 21, 2013. The content of the application is incorporated herein by reference in their entirety.

### FIELD

Embodiments described herein relate generally to a socket to which a straight tube type lamp is connected and a luminaire using the socket.

### BACKGROUND

Hitherto, there are plural standards for caps of straight tube type lamps and sockets to which the caps are mounted. A straight tube type lamp and a socket compatible to each other are combined and used, so that electrical characteristics of the straight tube type lamp and the equipment side using the socket conform to each other, and the straight tube type lamp can be normally lit.

In any standard, since the cap of the straight tube type lamp includes a pair of lamp pins, the socket is constructed so that a straight tube type lamp incompatible in combination can not be mounted.

However, in the respective standards, a pitch of a pair of lamp pins of a cap falls within a certain range. Thus, even within the range of the standard, there is a fear that the straight tube type lamp incompatible in combination can be mounted to the socket according to the pitch of the pair of lamp pins, and the pair of lamp pins of the straight tube type lamp are electrically connected to the pair of terminals of the socket, so that the electrical characteristics of the straight tube type lamp and the equipment side using the socket do not conform to each other.

### BRIEF DESCRIPTION OF THE DRAWINGS

FIG. 1 shows a first embodiment and is a back view of a socket in a state (a cover is removed) in which an incompatible straight tube type lamp is mounted.

FIG. 2 is a perspective view of a decomposed state of the socket.

FIG. 3 is a perspective view of the socket and a straight tube type lamp.

FIG. 4 is a perspective view of the straight tube type lamp.

FIG. 5 is a perspective view of a luminaire.

FIG. 6 is a back view of the socket before the compatible straight tube type lamp is mounted.

FIG. 7 is a back view of the socket during a process of mounting the compatible straight tube type lamp.

FIG. 8 is a back view of the socket in a state where the compatible straight tube type lamp is mounted.

FIG. 9 is a back view of the socket before the incompatible straight tube type lamp is mounted.

FIG. 10 is a back view of the socket during a process of mounting the incompatible straight tube type lamp.

FIG. 11 is a back view of the socket during the process of mounting the incompatible straight tube type lamp.

FIG. 12 is a back view of the socket when a pair of terminals are not pushed and expanded in the state where the incompatible straight tube type lamp is mounted.

FIG. 13 shows a second embodiment and is a back view of a socket in a state where an incompatible straight tube type lamp is mounted.

FIG. 14 shows a third embodiment and is a back view of a socket in a state where an incompatible straight tube type lamp is mounted.

### DETAILED DESCRIPTION

In general, according to one embodiment, a pair of lamp pins protruding from a cap of a straight tube type lamp are inserted into a socket and are rotated to a mount position, so that the straight tube type lamp is mounted. An insertion port in which the pair of lamp pins are inserted is provided in an outside surface of a socket body. An opening which connects with the insertion port and in which the pair of lamp pins inserted through the insertion port are rotated to the mount position is provided in a front surface of the socket body crossing the outside surface. A pair of terminals to which the pair of lamp pins rotated to the mount position are respectively connected are provided in the socket body. A rotor is rotatably disposed in the opening of the socket body. The rotor, together with the pair of lamp pins inserted through the insertion port, rotates, and pushes and expands an interval between the pair of terminals.

Since the rotor pushes and expands the interval between the pair of terminals, when an incompatible straight tube type lamp in which an outside pitch of a pair of lamp pins is smaller than that of a compatible straight tube type lamp is mounted to the socket, it is expected that the incompatible straight tube type lamp can be prevented from being electrically connected.

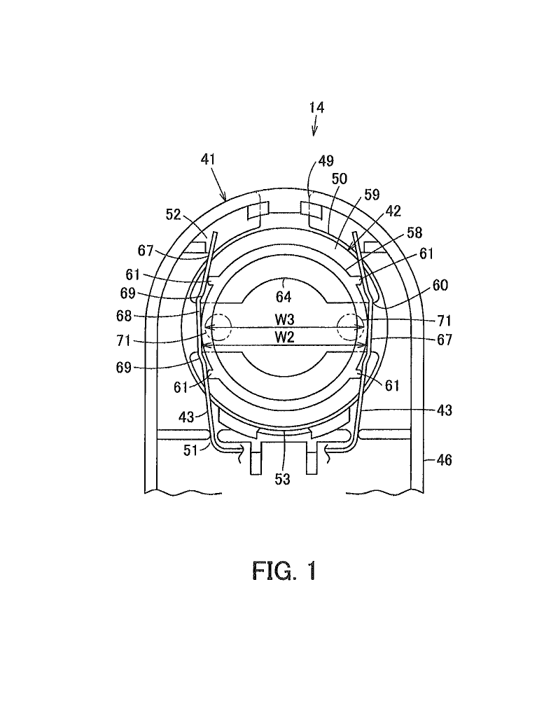

Hereinafter, a first embodiment will be described with reference to FIG. 1 to FIG. 12.

FIG. 5 is a perspective view of a luminaire 11 of a lamp system (LED lamp system) 10. The luminaire 11 is, for example, an embedded dual-lamp luminaire.

The luminaire 11 includes a long luminaire body 12, a straight tube type lamp 13 disposed in the luminaire body 12, sockets 14 and 15 which are disposed to face each other at both ends of the luminaire body 12 and to which both ends of the straight tube type lamp 13 are mounted, a power supply circuit 16 disposed in the luminaire body 12 and the like. The power supply circuit 16 receives AC power, converts it into DC power, and supplies the converted DC power to the straight tube type lamp 13 through the socket 14.

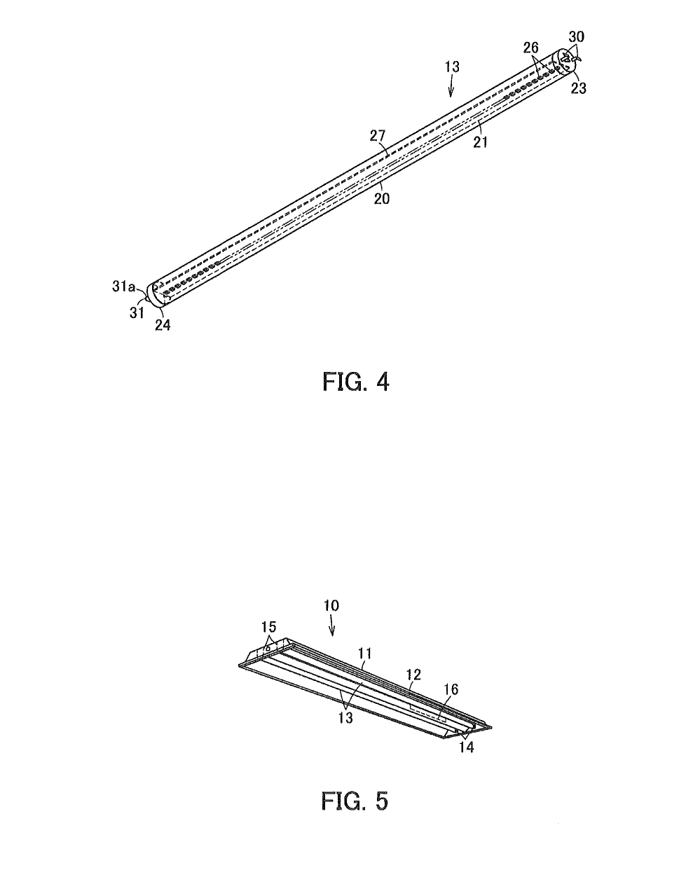

As shown in FIG. 4, the straight tube type lamp 13 includes a cylindrical translucent cover 20, a light-emitting module 21 contained in the translucent cover 20, and caps 23 and 24 disposed at both ends of the translucent cover 20.

The light-emitting module 21 includes plural semiconductor light-emitting elements 26 such as LED elements or EL elements, and a board 27 on which the plural semiconductor light-emitting elements 26 are mounted. When the semiconductor light-emitting elements 26 are LED elements, a surface-mount type SMD (Surface Mount Device) package is mounted on the board 27 or a COB (Chip On Board) module is used in which plural LED elements are mounted on the board 27.

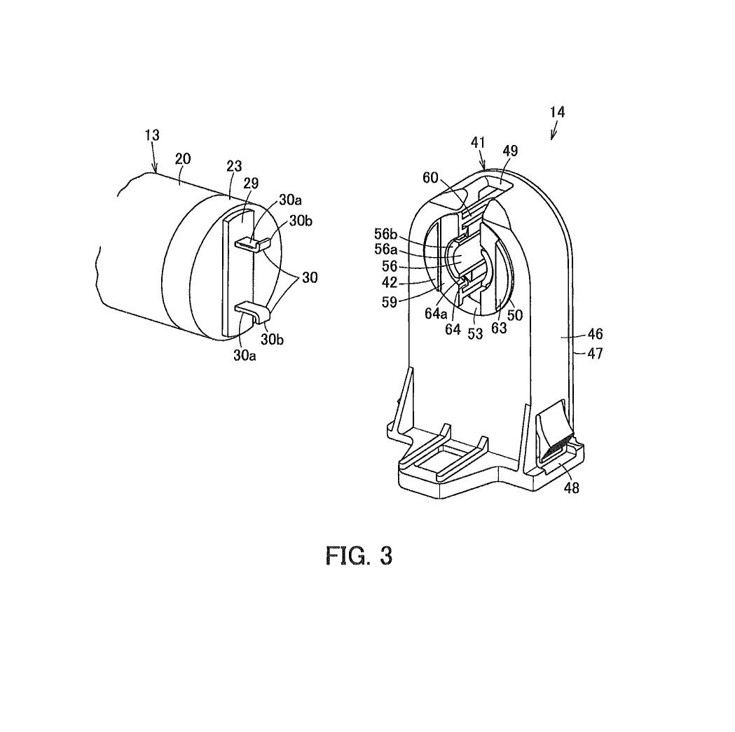

The cap 23 on one end side of the straight tube type lamp 13 complies with, for example, Japan Electric Lamp Manufactures Association of bulb standard JEL801 “a straight tube type LED lamp system with an L type pin cap GX16t-5”, and is not compatible with a G13 cap. As shown in FIG. 3, a projection part 29 passing through the tube axis of the straight tube type lamp 13 and protruding along the radial direction is formed on the end surface of the cap 23, and a pair of lamp pins 30 protrude from the projection 29 around the tube axis. The pair of lamp pins 30 are formed of metal plates with square sections, and each of them is formed into an L shape including a leg part 30a protruding along the longitudinal direction of the straight tube type lamp 13, and a bent part 30b protruding outward from the tip of the leg part 30a so as to be separated from the other leg part 30a.

The cap 23 on one end side of the straight tube type lamp 13 is the feeding side provided with the pair of lamp pins 30 as stated above, and the cap 24 at the other end is the non-feeding side. The cap 24 at the other end is provided with a protruding lamp pin 31 which is used for attachment to the socket 15 and can be used also for earth connection. An elliptical part 31a long in a direction orthogonal to the longitudinal direction of the straight tube type lamp 13 is formed at the tip of the lamp pin 31.

In the straight tube type lamp 13, a direction in which the pair of lamp pins 30 are arranged is coincident with a horizontally long direction of the elliptical part 31a of the lamp pin 31, and a surface parallel to these directions is parallel to the mounting surface of the board 27 on which the semiconductor light-emitting element 26 of the light-emitting module 21 is mounted.

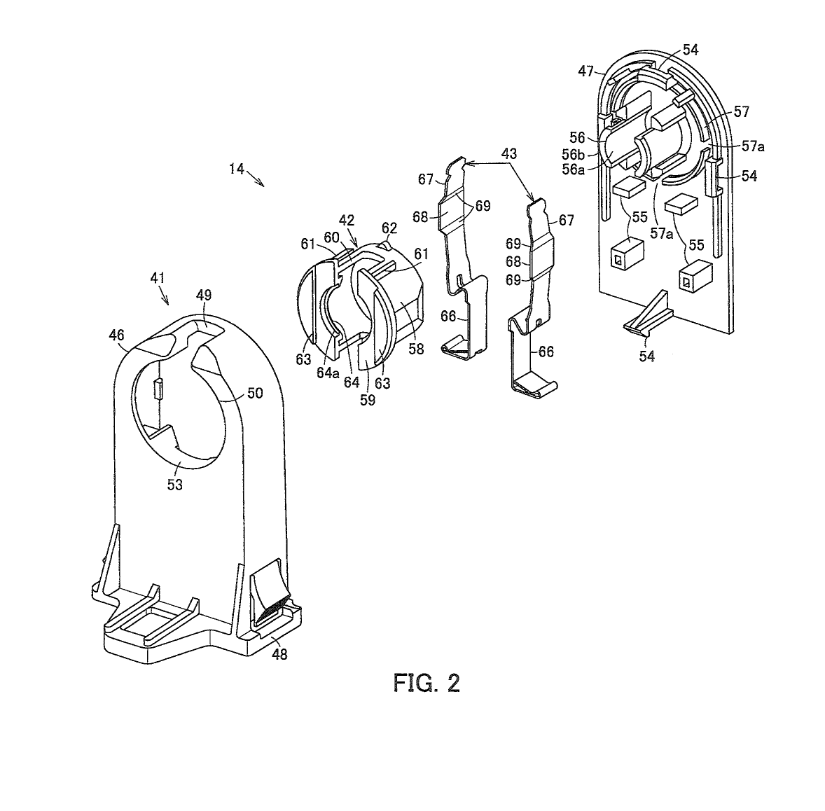

FIG. 2 and FIG. 3 show the feeding-side socket 14 to which the cap 23 on one end side of the straight tube type lamp 13 is connected. In the socket 14, a rotating mount system is used in which after the pair of lamp pins 30 of the straight tube type lamp 13 are inserted from the outside surface of the socket 14, the lamp pins are rotated by 90° around the tube axis of the straight tube type lamp 13 so that mounting is performed.

The socket 14 includes a socket body 41, a rotor 42 disposed in the socket body 41 and a pair of terminals 43. In the following, with respect to the socket 14, a side where the socket is attached to the luminaire body 12 is called a base end, and the opposite side is called a front end. Besides, a surface facing the end surface of the straight tube type lamp 13 is called a front surface, the opposite side is called a back surface, and a surface between the front surface and the back surface is called a side surface.

The socket body 41 is made of a synthetic resin having insulation properties, and includes a case 46 having an opened back surface, and a cover 47 attached to the back surface of the case 46.

An attachment part 48 to be attached to the luminaire body 12 is provided at the base end of the case 46. An insertion port 49 in which the pair of lamp pins 30 of the straight tube type lamp 13 can be inserted is formed in the front end surface of the case 46. A circular opening 50 connecting with the insertion port 49 is formed in the front surface of the case 46. The leg parts 30a of the pair of lamp pins 30 inserted from the insertion port 49 to a specified rotation position (insertion position) can be rotated in the opening 50.

As shown in FIG. 1 (back view of the socket 14 in the state where the cover 47 is removed), a pair of terminal holding parts 51 to hold the base end sides of the pair of terminals 43 and a pair of terminal holding parts 52 to hold the front end sides of the pair of terminals 43 are formed in the case 46. A pair of electric wire insertion holes in which electric wires to be connected to the pair of terminals 43 are inserted are formed at the base end side of the case 46.

A wall part 53 protruding from the front surface side to the back surface side is formed in the case 46 and at an edge part of the opening 50 on the opposite side to the insertion port 49 of the front end and facing the insertion port 49. The wall part 53 is constructed such that the leg part 30a of one of the lamp pins 30 first inserted from the insertion port 49 contacts, and the pair of lamp pins 30 are positioned at the rotation position.

As shown in FIG. 2, plural locking parts 54 locked to the case 46 in the state where the back surface of the case 46 is closed are formed on the front surface of the cover 47. Plural support protrusions 55, which position and support the terminals 43 between the case 46 and the cover 47, are protrudingly provided on the front surface of the cover 47. Further, a pair of support parts 56 to rotatably support the rotor 42 are protrudingly provided on the front surface of the cover 47 and at the concentric position to the opening 50 of the case 46. Besides, a guide wall 57 is protrudingly provided along the periphery of the support parts 56. A groove part 56a through which the lamp pin 30 can pass is formed between the pair of support parts 56, and pawl parts 56b to retain the rotatably supported rotor 42 are formed at the front ends of the pair of support parts 56. A cutout part 57a for giving moderation to the rotor 42 at a specified rotation position is formed at every 90° in the guide wall 57.

Besides, as shown in FIG. 1 to FIG. 3, the rotor 42 includes a cylindrical tubular part 58 made of a synthetic resin having insulation properties and rotatably fitted to the periphery of the support parts 56 of the cover 47, and a front surface part 59 rotatably disposed in the opening 50 of the case 46. In the state where the rotor 42 is incorporated in the socket body 41, the tubular part 58 is disposed between the pair of terminals 43, and the outer circumferential surface of the tubular part 58 faces the pair of terminals 43.

A groove part 60 to allow passing of the lamp pin 30 is formed along the radial direction and over the front surface part 59 from the front side of the tubular part 58. Press parts 61 which contact the pair of terminals 43, and push and expand the interval between the pair of terminals 43 are protrudingly provided on the outer circumferential surface of the tubular part 58 and at both side positions of the groove part 60. Incidentally, a position where the groove part 60 of the rotor connects with the insertion port 49 is called an attachment-detachment position, and a position rotated relative to the attachment-detachment position by 90° is called a mount position.

The rear part of the tubular part 58 is disposed between the support part 56 and the guide wall 57, and a pair of positioning protrusions 62 are protrudingly formed on the rear outer circumferential surface of the rotor 42 and at two places parallel to the groove direction of the groove part 60. The positioning protrusions 62 engage with the cutout parts 57a of the guide wall 57, and give moderation to the attachment-detachment position and the mount position of the rotor 42. A part of the rotor 42 is elastically deformed in the periphery of the positioning protrusion 62, so that the positioning protrusion 62 contacts the inner circumferential surface of the guide wall 57 and slides on the inner circumferential surface, and the rotation of the rotor 42 is allowed.

A pair of guide protrusions 63 which protrude from the front surface of the case 46 and to which the projection 29 of the cap 23 of the straight tube type lamp 13 is slide-fitted are protrudingly formed on the front surface part 59. Further, an arc-shaped fitting part 64 rotatably fitted to the periphery of the support part 56 is formed on the front surface part 59, and a stepped part 64a to which the pawl part 56b of the support part 56 is locked is formed on the fitting part 64.

The pair of terminals 43 are formed of plate springs having conductive properties. Each of the terminals 43 includes a base end part 66 which is held between the case 46 and the cover 47 and to which an electric wire inserted from the electric wire insertion hole of the case 46 is connected, and a connection part 67 to be connected to the lamp pin 30.

The base end side of the connection part 67 is held by the terminal holding part 51 of the case 46, and the front end side thereof is disposed inside the terminal holding part 52 of the case 46. A contact surface 68 having a concave shape on the side of contact with the lamp pin 30, and inclined surfaces 69 continuous with the base end side and the front end side of the contact surface 68 are formed on an intermediate part between the base end side and the front end side of each of the connection parts 67. The connection parts 67 of the pair of terminals 43 have spring properties so as to move in the direction in which the interval between the pair of terminals 43 becomes narrow.

The width sizes of the insertion port 49 of the socket body 41, the groove part 60 of the rotor 42, and the groove part 56a of the support part 56 are slightly wider than the width size of the lamp pin 30, and are formed into such sizes that the lamp pin 30 can be inserted.

Incidentally, with respect to the non-feeding side socket 15 to which the cap 24 on the other end side of the straight tube type lamp 13 is connected, the rotating mount system is used in which after one pin protruding from the cap 24 on the other end side is inserted from the outside surface of the socket 15, the pin is rotated by 90° around the tube axis of the straight tube type lamp 13 so that mounting is performed.

Next, a case where the straight tube type lamp 13 compatible with the socket 14 is mounted will be described.

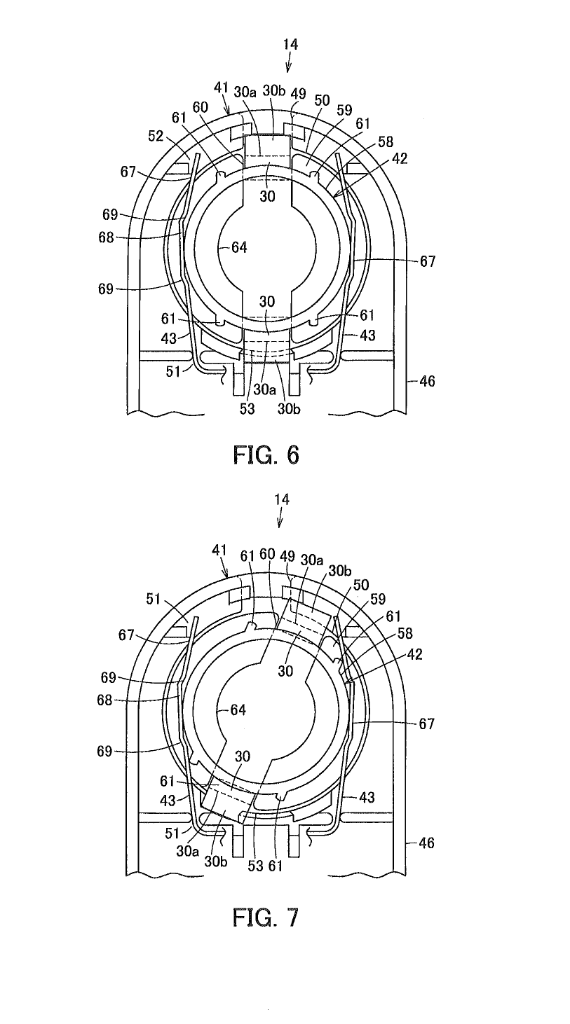

As shown in FIG. 6 to FIG. 8, after the pair of lamp pins 30 protruding from the cap 23 of the straight tube type lamp 13 are inserted from the insertion port 49 of the socket 14 to a specified rotation position, the lamp pins are rotated by 90° around the tube axis of the straight tube type lamp 13, so that the straight tube type lamp 13 is mounted to the socket 14 in an electrical connection state.

That is, as shown in FIG. 6, the pair of lamp pins 30 are inserted from the insertion port 49 of the socket 14 into the groove part 60 of the rotor 42 and the groove part 56a of the support part 56. The leg part 30a of one of the lamp pins 30 first inserted from the insertion port 49 contacts the wall part 53, and the insertion of the pair of lamp pins 30 is regulated by the rotation position of the socket 14. The pair of lamp pins 30 are positioned at the rotation position, so that the pair of lamp pins 30 are disposed in the rotor 42, and the straight tube type lamp 13, together with the rotor 42, can be rotated relative to the socket 14.

The pair of lamp pins are rotated around the tube axis of the straight tube type lamp 13 in the direction in which the light emitting direction of the straight tube type lamp 13 is directed to a specified irradiation direction. By this, the pair of lamp pins 30 contact the rotor 42 on the outer diameter side of the support part 56 of the cover 47, and the rotor 42, together with the straight tube type lamp 13, rotates.

As shown in FIG. 7, when the rotor 42 rotates, the respective press parts 61 of the rotor 42 contact the pair of terminals 43, and push and expand the interval between the pair of terminals 43. When the rotor 42 further rotates, the leg parts 30a of the pair of lamp pins 30 contact the pair of terminals 43, and further push and expand the interval between the pair of terminals 43, and the pair of terminals 43 are separated from the respective press parts 61.

When the rotor 42 rotates, the positioning projection 62 of the rotor 42 moves away from the cutout part 57a of the guide wall 57 and rotates while sliding on the inner circumferential surface of the guide wall 57. When the pair of lamp pins 30 rotate to the specified mount position, the positioning projection 62 of the rotor 42 is fitted in the other cutout part 57a of the guide wall 57, and a load is applied to the rotation of the straight tube type lamp 13. Thus, it can be confirmed that the straight tube type lamp 13 is rotated to the specified mount position.

When the straight tube type lamp 13 is rotated to the mount position, the groove part 60 of the rotor 42 moves away from the position of the insertion port 49 of the socket 14 and is closed by the edge of the opening 50. Thus, the pair of lamp pins 30 are prevented from falling off from the insertion port 49 of the socket 14.

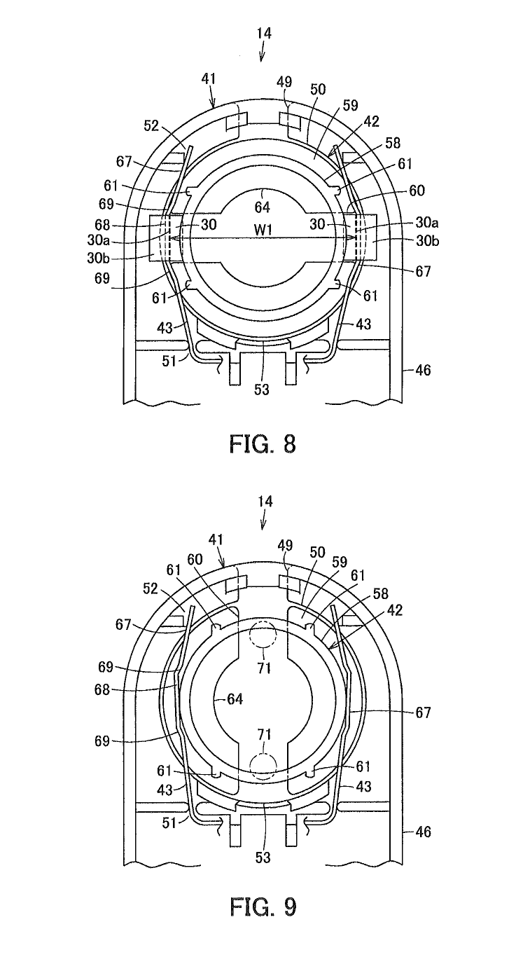

As shown in FIG. 8, in the state where the straight tube type lamp 13 is rotated to the mount position, the leg parts 30a of the pair of lamp pins 30 contact the connection parts 67 of the pair of terminals 43, and push and expand the interval between the pair of terminals 43. By this, the pair of terminals 43 come in press contact with the pair of lamp pins 30, and these are electrically connected to each other. Incidentally, an outside pitch between the pair of lamp pins 30 is W1, and an inside pitch between the pair of terminals 43 in contact with the pair of lamp pins 30 is also W1.

In the state where the straight tube type lamp 13 is rotated to the mount position, although the respective press parts 61 of the rotor 42 face the pair of terminals 43, since the interval between the pair of terminals 43 is pushed and expanded by the pair of lamp pins 30, the terminals are separated from the respective press parts 61.

The inside surfaces of the pair of lamp pins 30 facing each other face the outer circumferential surfaces of the support parts 56, and the position in the direction in which the pair of lamp pins 30 are arranged side by side is determined by the support parts 56. Thus, the straight tube type lamp 13 mounted to the socket 14 can be prevented from being inclined.

When the straight tube type lamp 13 is removed, for example, the straight tube type lamp 13 is rotated by 90° in the opposite direction to that at the time of mounting. By this, since the groove part 60 of the rotor 42, which rotates together with the pair of lamp pins 30, coincides with the insertion port 49 of the socket 14, the pair of lamp pins 30 can be pulled out through the insertion port 49 of the socket 14.

Although the mounting and removing of the cap 23 and the socket 14 at the feeding side is described, mounting and removing of the cap 24 and the socket 15 at the non-feeding side is also performed in the same rotating mount system.

In the luminaire 11 in which the straight tube type lamp 13 is mounted, electric power is supplied from the power supply circuit 16 through the socket 14 to the light-emitting module 21 of the straight tube type lamp 13, and the semiconductor light-emitting element 26 is lit. The light from the lit semiconductor light-emitting element 26 passes through the translucent cover 20 and is irradiated in the specified irradiation direction.

Next, description will be made on a case where, as a straight tube type lamp with a different kind of cap with respect to the socket 14, for example, a straight tube type lamp with a G13 cap is erroneously attempted to be mounted. Incidentally, the straight tube type lamp with the different kind of cap with respect to the socket 14 is called an incompatible straight tube type lamp.

As shown in FIG. 1 and FIG. 9 to FIG. 11, the G13 cap includes a pair of column-shaped lamp pins 71. An outside pitch W3 between the pair of lamp pins 71 is smaller than the outside pitch W1 between the pair of lamp pins 30 of the straight tube type lamp 13.

As shown in FIG. 9, when the pair of lamp pins 71 of the incompatible straight tube type lamp are inserted from the insertion port 49 of the socket 14 into the groove part 60 of the rotor 42 and the groove part 56a of the support part 56 and are rotated, the pair of lamp pins 71 contact the support parts 56 of the cover 47, and the rotation is regulated. Thus, the incompatible straight tube type lamp can not be mounted to the socket 14.

However, according to the standard of the G13 cap, since the pitch of the pair of lamp pins 71 is within a certain range, when the pitch is maximum within the range, there is a case where the pair of lamp pins 71 are not rotation-regulated by the support parts 56 of the cover 47 and can be rotated.

In this case, when rotated around the tube axis of the incompatible straight tube type lamp, the pair of lamp pins 71 contact the rotor 42 at the outer diameter side of the support parts 56 of the cover 47, and the rotor 42, together with the incompatible straight tube type lamp, rotates.

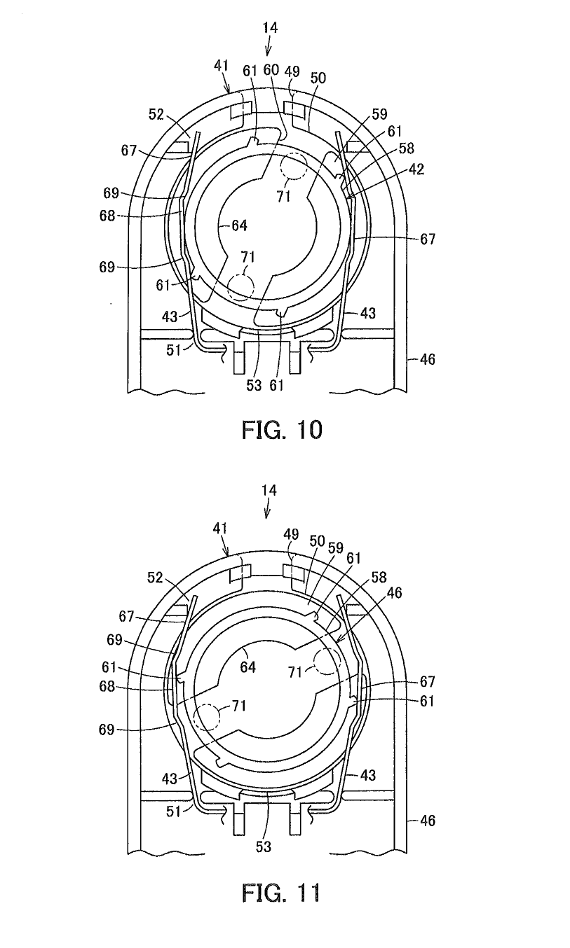

As shown in FIG. 10, when the rotor 42 rotates, the respective press parts 61 of the rotor 42 contact the pair of terminals 43. Then, when the rotor 42 further rotates as shown in FIG. 11, the respective press parts 61 of the rotor 42 push and expand the interval between the pair of terminals 43. Thus, even if one of the lamp pins 71 contacts one of the terminals 43, both of the pair of lamp pins 71 do not simultaneously contact both of the pair of terminals 43.

As shown in FIG. 1, in the state where the incompatible straight tube type lamp is rotated to the mount position, the respective press parts 61 of the rotor 42 contact the pair of terminals 43, and push and expand the interval between the pair of terminals 43. An inside pitch between the pair of terminals 43 pushed and expanded by the respective press parts 61 of the rotor 42 is W2 and is larger than the outside pitch W3 between the pair of lamp pins 71. Thus, even if one of the lamp pins 71 contacts one of the terminals 43, both of the pair of lamp pins 71 do not simultaneously contact both of the pair of terminals 43. Accordingly, the incompatible straight tube type lamp is not electrically connected to the socket 14.

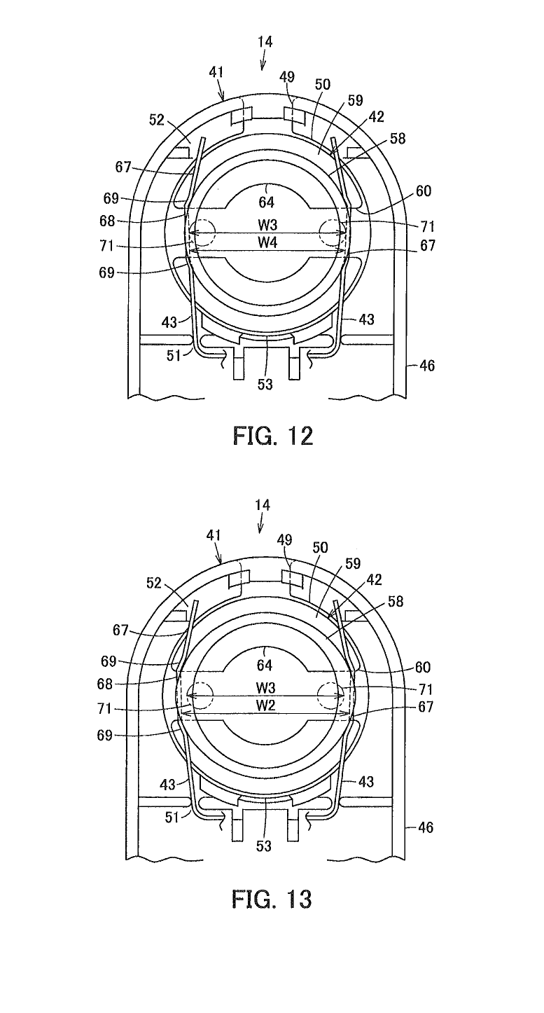

FIG. 12 shows an example of a case where the press parts 61 of the rotor 42 do not push and expand the pair of terminals 43. When the rotor 42, together with the pair of lamp pins 71, rotates to the mount position, the pair of terminals 43 enter the groove part 60, and the interval between the pair of terminals 43 becomes narrow. When an inside pitch W4 between the pair of narrowed terminals 43 becomes smaller than the outside pitch W3 between the pair of lamp pins 71, there is a fear that both of the pair of lamp pins 71 simultaneously contact both of the pair of terminals 43, the incompatible straight tube type lamp is electrically connected to the socket 14, and inconsistency of electrical characteristics occurs between the straight tube type lamp 13 and the equipment side using the socket 14.

The outside pitch W1 between the pair of lamp pins 30 of the straight tube type lamp 13 is larger than the inside pitch W2 between the pair of terminals 43 pushed and expanded by the press parts 61 of the rotor 42. Thus, as shown in FIG. 8, the leg parts 30a of the pair of lamp pins 30 contact the pair of terminals 43, and in the state where the interval between the pair of terminals 43 is pushed and expanded, the pair of terminals 43 are separated from the respective press parts 61.

According to the socket 14 constructed as described above, since the interval between the pair of terminals 43 is pushed and expanded by the rotor 42, even if the incompatible straight tube type lamp in which the outside pitch between the pair of lamp pins is smaller than that of the compatible straight tube type lamp is mounted, the incompatible straight tube type lamp can be prevented from being electrically connected.

Besides, since the rotor 42 pushes and expands the interval between the pair of terminals 43 during the period from the initial stage of rotation to the end stage of rotation of the pair of lamp pins to the mount position, the incompatible straight tube type lamp can be prevented from being electrically connected to the socket 14.

Besides, since the rotor 42 pushes and expands the interval between the pair of terminals 43 from the initial stage of rotation of the pair of lamp pins to the mount position, both of the pair of lamp pins 71 of the incompatible straight tube type lamp do not simultaneously contact both of the pair of terminals 43, and also in the mounting process, the incompatible straight tube type lamp can be prevented from being electrically connected to the socket 14.

Besides, the rotor 42 pushes and expands the interval between the pair of terminals 43 from the initial stage of rotation of the pair of lamp pins 30 to the mount position, and the pair of lamp pins 30 contact the pair of terminals 43 at the time of completion of the rotation to the mount position. Accordingly, the compatible straight tube type lamp 13 can be electrically connected to the socket 14.

Besides, since the pair of lamp pins 30 respectively contact the pair of terminals 43 at the mount position, and push and expand the interval between the pair of terminals 43, stable electrical connection can be achieved.

The rotor 42 can push and expand the interval between the pair of terminals 43 by the press parts 61 protruding from the tubular part 58 facing the pair of terminals 43. Incidentally, when the press parts 61 are provided in the vicinity of the groove part 60 or the edge of the groove part 60, the interval between the pair of terminals 43 can be certainly pushed and expanded.

Besides, since the inside pitch W2 between the pair of terminals 43 pushed and expanded by the rotor 42 is made wider than the outside pitch W3 between the pair of lamp pins 71 of the G13 cap, the straight tube type lamp using the G13 cap can be prevented from being electrically connected to the socket 14.

FIG. 13 shows a second embodiment. Incidentally, the same components, operations and effects as those of the first embodiment are denoted by the same reference signs and their explanation is omitted.

A direction along the groove part 60 of the tubular part 58 of the rotor 42 is made the major axis, and a direction orthogonal to the groove part 60 is made the minor axis. The outer circumferential shape of the tubular part 58 is formed into an elliptical shape.

When the rotor 42 rotates to the mount position, the outer circumferential surface of the tubular part 58 on the major axis side pushes and expands the interval between the pair of terminals 43. That is, the state corresponds to the state where the respective press parts 61 of the rotor 42 of the first embodiment push and expand the interval between the pair of terminals 43.

The inside pitch W2 between the pair of terminals 43 pushed and expanded by the outer circumferential surface of the tubular part 58 on the major axis side is wider than the outside pitch W3 between the pair of lamp pins 71 of the G13 cap, and is narrower than the outside pitch W1 between the pair of lamp pins 30 of the straight tube type lamp 13. Thus, the incompatible straight tube type lamp can be prevented from being electrically connected to the socket 14, and the compatible straight tube type lamp 13 can be electrically connected to the socket 14.

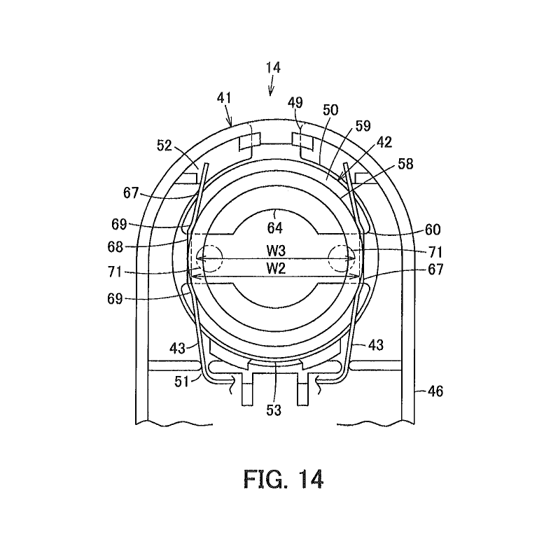

FIG. 14 shows a third embodiment. Incidentally, the same components, operations and effects as those of the respective embodiments are denoted by the same reference signs and their explanation is omitted.

An outer diameter size of the tubular part 58 of the rotor 42 is made larger than that of the first embodiment, and an interval between the pair of terminals 43 is always pushed and expanded. The inside pitch W2 between the pushed and expanded pair of terminals 43 is wider than the outside pitch W3 between the pair of lamp pins 71 of the G13 cap, and is made narrower than the outside pitch W1 between the pair of lamp pins 30 of the straight tube type lamp 13. Thus, the incompatible straight tube type lamp can be prevented from being electrically connected to the socket 14, and the compatible straight tube type lamp 13 can be electrically connected to the socket 14.

When there is a fear that the spring force is lowered by pushing and expanding the interval between the pair of terminals 43 also at the time when the straight tube type lamp 13 is not mounted, as in the first embodiment and the second embodiment, it is preferable to adopt a structure of pushing and expanding the interval between the pair of terminals 43 only at the time when an incompatible straight tube type lamp is mounted.

Incidentally, the straight tube type lamp 13 may have a built-in power supply circuit, and AC power may be supplied from an equipment side to the power supply circuit of the straight tube type lamp 13 through the socket 14. In this case, when the pitch between the pair of lamp pins 71 is the upper limit size in the standard of the G13 cap and the input voltage of the straight tube type lamp is 200 V, if a gap of 0.2 mm or more exists between the pair of the lamp pins 71 and the pair of the terminals 43, insulation properties can be ensured.

Besides, the shape of the lamp pins 30 of the straight tube type lamp 13 is not limited to that of the outward lamp pins 30 in which the bent parts 30b protrude from the front ends of the pair of leg parts 30a in the outward direction so as to be separated from each other, and inward lamp pins may be adopted in which the bent parts are bent in the inward direction from the front ends of the pair of leg parts 30a so as to approach each other, or lamp pins of other shapes may be adopted.

While certain embodiments have been described, there embodiments have been presented by way of example only, and are not intended to limit the scope of the inventions. Indeed, the novel embodiments described herein may be embodied in a variety of the other forms; furthermore, various omissions, substitutions, and changes in the form of the embodied described herein may be made without departing from the spirit of the inventions. The accompanying claims and their equivalents are intended to cover such forms or modifications as would fall within the scope and spirit of the inventions.

What is claimed is:

1. A socket to which a straight tube type lamp is mounted by inserting a pair of lamp pins protruding from a cap of the straight tube type lamp and by rotating the pair of lamp pins to a mount position, the socket comprising:
a socket body including an insertion port which is provided in an outside surface and into which the pair of lamp pins are inserted, and an opening which is provided in a front surface crossing the outside surface and connects with the insertion port and in which the pair of lamp pins inserted through the insertion port are rotated to the mount position;
a pair of terminals which are provided in the socket body and to which the pair of lamp pins rotated to the mount position are connected; and
a rotor which is rotatably disposed in the opening, rotates together with the pair of lamp pins inserted through the insertion port, and pushes and expands an interval between the pair of terminals.

2. The socket according to claim 1, wherein the rotor pushes and expands the interval between the pair of terminals during a period from an initial stage of rotation to an end stage of rotation of the pair of lamp pins to the mount position.

3. The socket according to claim 1, wherein the rotor pushes and expands the interval between the pair of terminals from an initial stage of rotation of the pair of lamp pins to the mount position.

4. The socket according to claim 1, wherein
the rotor pushes and expands the interval between the pair of terminals from an initial stage of rotation of the lamp pins to the mount position, and
the pair of lamp pins contact the pair of terminals at a time of completion of the rotation to the mount position.

5. The socket according to claim 1, wherein the rotor always pushes and expands the interval between the pair of terminals.

6. The socket according to claim 1, wherein the pair of lamp pins are respectively connected to the pair of terminals at the mount position, and push and expand the interval between the pair of terminals.

7. The socket according to claim 1, wherein the rotor includes a tubular part facing the pair of terminals, and press parts protruding from the tubular part to push and expand the interval between the pair of terminals.

8. The socket according to claim 1, wherein the rotor includes an elliptical tubular part which contacts the pair of terminals.

9. The socket according to claim 1, wherein an inside pitch between the pair of terminals pushed and expanded by the rotor is wider than an outside pitch between a pair of lamp pins of a G13 cap.

10. A luminaire comprising:
a straight tube type lamp including a cap provided with a pair of protruding lamp pins; and
a socket including: a socket body including an insertion port which is provided in an outside surface and into which the pair of lamp pins are inserted, and an opening which is provided in a front surface crossing the outside surface and connects with the insertion port and in which the pair of lamp pins inserted through the insertion port are rotated to a mount position; a pair of terminals which are provided in the socket body and to which the pair of lamp pins rotated to the mount position are connected; and a rotor which is rotatably disposed in the opening, rotates together with the pair of lamp pins inserted through the insertion port, and pushes and expands an interval between the pair of terminals.

11. The luminaire according to claim 10, wherein the rotor pushes and expands the interval between the pair of terminals during a period from an initial stage of rotation to an end stage of rotation of the pair of lamp pins to the mount position.

12. The luminaire according to claim 10, wherein the rotor pushes and expands the interval between the pair of lamp pins from an initial stage of rotation to the mount position.

13. The luminaire according to claim 10, wherein
the rotor pushes and expands the interval between the pair of lamp pins from an initial stage of rotation to the mount position, and
the pair of lamp pins contact the pair of terminals at a time of completion of the rotation to the mount position.

14. The luminaire according to claim 10, wherein the rotor always pushes and expands the interval between the pair of terminals.

15. The luminaire according to claim 10, wherein the pair of lamp pins are respectively connected to the pair of terminals at the mount position, and push and expand the interval between the pair of terminals.

16. The luminaire according to claim 10, wherein the rotor includes a tubular part facing the pair of terminals, and press parts protruding from the tubular part to push and expand the interval between the pair of terminals.

17. The luminaire according to claim 10, wherein the rotor includes an elliptical tubular part which contacts the pair of terminals.

18. The luminaire according to claim 10, wherein an inside pitch between the pair of terminals pushed and expanded by the rotor is wider than an outside pitch between a pair of lamp pins of a G13 cap.
